(19) United States
(12) Patent Application Publication
(10) Pub. No.: US 2008/0127287 A1
(43) Pub. Date: May 29, 2008

(54) APPARATUS AND METHOD FOR EMBEDDING/DETECTING AN AUXILIARY SIGNAL WITHIN A CATV TRAFFIC STREAM

(75) Inventors: Erdogan Alkan, Syracuse, NY (US); Ahmet Burak Olcen, Syracuse, NY (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: John Mezzalingua Associates, Inc., East Syracuse, NY (US)

(21) Appl. No.: 11/563,749

(22) Filed: Nov. 28, 2006

(51) Int. Cl. H04N 7/173

(52) U.S. Cl. 725/107

(57) ABSTRACT

An apparatus for embedding/detecting an auxiliary signal within a cable television (CATV) traffic stream is configured for inclusion within a legacy CATV system configured for sending one or more CATV signals in respective one or more frequency bands. The apparatus includes a controller configured for receiving an input signal and an auxiliary signal, and watermarking the input signal with the auxiliary signal to thereby form a watermarked signal. The input signal comprises one of the CATV signals of the CATV system, the watermarked signal being sent to the detector in the same frequency band as the respective CATV signal. The controller is also configured for sending the watermarked signal to a detector for detecting and removing the auxiliary signal from the watermarked signal to thereby recover the input signal and the auxiliary signal.

### FIELD OF THE INVENTION

Embodiments of the present invention generally relate to apparatuses and methods for transmitting auxiliary signals embedded within primary signals and, more particularly, relate to apparatuses and methods for transmitting auxiliary signals embedded within primary broadcast signals of a cable television (CATV) network.

### BACKGROUND OF THE INVENTION

Cable communication systems typically comprise a head-end facility from which a plurality of main distribution lines emanate in a hub-and-spoke arrangement. Each main distribution line serves one or more local distribution networks each of which services a relatively small number (e.g., about 100 to 250) of individual subscribers. Each subscriber is connected with the main distribution line via a feeder line that taps into the main distribution line at a feeder tap location.

In the early history of cable television, communications were strictly unidirectional, i.e., from the service provider to the subscribers. More recently, however, many service providers have begun to offer bidirectional services in which signals are also sent from the subscribers to the service provider. For example, cable television (CATV) service providers frequently offer impulse pay-per-view services where the subscriber may impulsively select an event for viewing and incur a charge. The pay-per-view service employs at least one data channel such as a telephone communication channel or an RF channel in an upstream (reverse) direction from the cable television subscriber to a cable television head-end for reporting service usage data. Other uses for a return path include internet access, active device status monitoring, power meter reading, alarm services, subscriber polling and voting, collecting subscriber viewing statistics, home shopping, and telephony.

Bi-directional cable communication systems usually utilize one frequency band for forward or downstream signals that are sent from the service provider to the subscribers, and a different frequency band for return or upstream signals sent from the subscribers to the service provider. These systems have typically used the higher of the frequency bands for forward transmission and the lower of the frequency bands for return transmission. Forward transmissions, for example, have been provided in the 54 to 1000 MHz band. Return transmissions have generally been provided in the 5 to 40 MHz band. Within each of these bands, portions are often allocated for particular traffic streams, such as by allocating portions of the forward band for particular television channel traffic streams. Whereas such allocation of frequency bands for forward and return transmissions, and allocating portions of those bands for particular traffic streams, is adequate for communicating across the system, such allocations may be undesirable in various instances. Dedicated frequency bands or portions of a particular band may be undesirable, for example, where an additional transmission is desired at a particular frequency band or at particular portion of a frequency band that has already been allocated to other transmissions, or where additional transmissions are desired but the entire band has already been allocated to other transmissions.

### SUMMARY OF THE INVENTION

In view of the foregoing background, exemplary embodiments of the present invention provide an apparatus and method for embedding/detecting an auxiliary signal within a cable television (CATV) traffic stream. Exemplary embodiments of the present invention watermark a CATV signal with an auxiliary signal such that the resulting watermarked signal may be sent in the same frequency band as the CATV signal within an existing or legacy CATV system within which exemplary embodiments of the present invention may operate. The added, auxiliary signal may be in burst nature or include less information than the original CATV signal, and/or may be utilized for third-party (e.g., vendor) device communication. By watermarking the CATV signal with an auxiliary signal, exemplary embodiments of the present invention may conserve bandwidth and/or allow a source of the auxiliary signal (e.g., a vendor) to use a number of different frequencies with less restriction on its selection.

According to one aspect of the present invention, an apparatus for embedding/detecting an auxiliary signal within a CATV traffic stream is configured for inclusion within a legacy CATV system configured for sending one or more CATV signals in respective one or more frequency bands. In this regard, the CATV system may include one or more such apparatuses located at various points within the CATV system, such as at a head-end facility and/or along a trunk (e.g., at a connector, trap, etc.) of the CATV system. The apparatus includes a controller configured for receiving an input signal and an auxiliary signal, and watermarking the input signal with the auxiliary signal to thereby form a watermarked signal.

The auxiliary signal may include measurements of one or more conditions of the apparatus or proximate the apparatus received by one or more sensors in communication with the controller, such as when the apparatus is located along a trunk of the CATV system. The input signal comprises one of the CATV signals of the CATV system, and as such, the watermarked signal may be sent to the detector in the same frequency band as the respective CATV signal. The controller is also configured for sending the watermarked signal to a detector for detecting and removing the auxiliary signal from the watermarked signal to thereby recover the input signal and the auxiliary signal.

The detector may form a portion of another apparatus. In such instances, the controller may be configured for sending the watermarked signal to the detector such that the other apparatus forwards the recovered input signal to a head-end facility (e.g., when the other apparatus is located at the head-end facility) or a consumer electronics (CE) device (e.g., when the other apparatus is located along a trunk) of the CATV system. Also in such instances, the auxiliary signal may include control information for directing operation of the other apparatus. For example, the control information may include one or more commands for directing the other apparatus to acquire measurements of one or more conditions of the other apparatus or proximate the other apparatus, such as when the other apparatus is located along a trunk of the CATV system.

In addition to or in lieu of watermarking a CATV signal, the apparatus may be configured for receiving a watermarked signal and detecting and removing an auxiliary signal therefrom. In such instances when the apparatus is configured for both embedding and detecting functions, the input signal, auxiliary signal and watermarked signal with relation to the embedding functions may comprise first signals. The controller may then be further configured for receiving a second watermarked signal from an embedder that previously formed the watermarked signal by watermarking a second input signal with a second auxiliary signal. The controller may be configured to then detect and remove the second auxiliary signal from the second watermarked signal to thereby recover the second input signal and the second auxiliary signal. Similar to the first input signal, the second input signal may comprise one of the CATV signals of the CATV system such that the controller receives the second watermarked signal in the same frequency band as the respective CATV signal. The controller may be further configured for forwarding the recovered second input signal to a head-end facility or CE device of the CATV system.

The embedder from which the controller receives the second watermarked signal may form a portion of another apparatus, whether the same or a further apparatus other than that to which the controller may send a watermarked signal. In such instances, the second auxiliary signal may include measurements of one or more conditions of the other apparatus or proximate the other apparatus, again such as when the other apparatus is located along a trunk of the CATV system. As another example (e.g., when the apparatus is located along a trunk), the second auxiliary signal may include control information for directing operation of the apparatus, such as one or more commands for directing the apparatus to acquire measurements of one or more conditions of the apparatus or proximate the apparatus. The controller then may be configured for acquiring the measurements in response to the commands.

According to other aspects of the present invention, a method for embedding/detecting an auxiliary signal within a CATV traffic stream is provided. As indicated above and explained below, the apparatus and method of exemplary embodiments of the present invention may solve the problems identified by prior techniques and/or provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 is a diagrammatic depiction of a portion of a cable system in accordance with exemplary embodiments of the present invention;

FIG. 2 is a schematic block diagram of an embedding/detecting apparatus in accordance with exemplary embodiments of the present invention;

FIG. 3 is a functional block diagram of a system for embedding/detecting an auxiliary signal within a traffic stream, in accordance with one exemplary embodiment of the present invention;

FIG. 4 is a functional block diagram of an embedder in accordance with one exemplary embodiment of the present invention;

FIG. 5 is a functional block diagram of a detector in accordance with one exemplary embodiment of the present invention; and

FIG. 6 is a flowchart including various steps in a method of embedding/detecting an auxiliary signal within a traffic stream, in accordance with exemplary embodiments of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

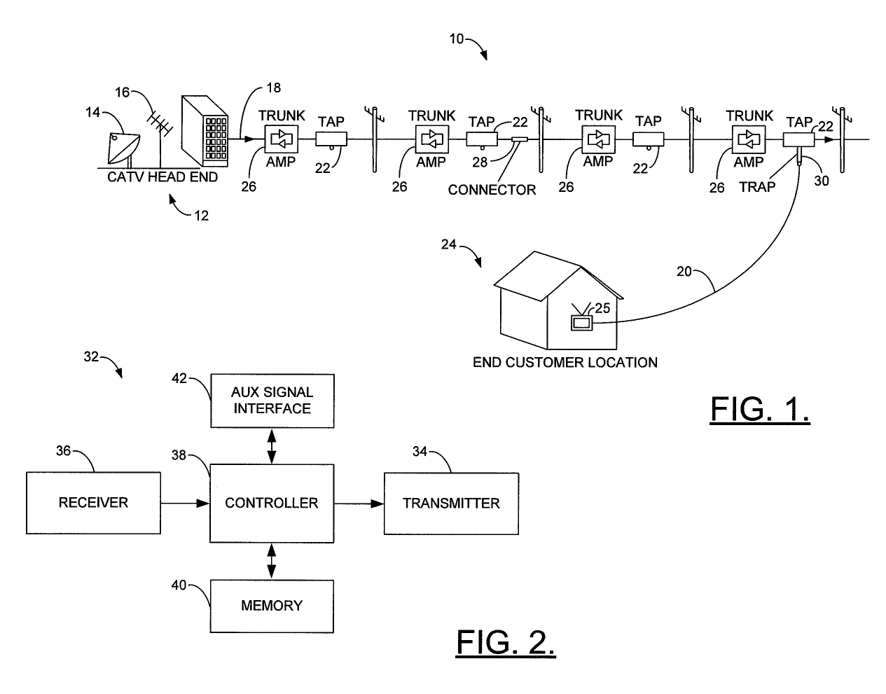

Referring to FIG. 1, an illustration of one type of system that would benefit from exemplary embodiments of the present invention is provided. The system, apparatus and method of exemplary embodiments of the present invention will be primarily described in conjunction with cable television (CATV) network applications. It should be understood, however, that the system, apparatus and method of exemplary embodiments of the present invention can be utilized in conjunction with a variety of other applications, both in the CATV industries and outside of the CATV industries.

As shown, the CATV system 10 of exemplary embodiments of the present invention includes a head-end facility 12 for receiving information signals, such as television (TV) signals, data signals or the like, via one or more satellite dishes 14 and/or antennas 16, for example. The head-end facility is configured to transmit these signals over a plurality of main distribution lines or trunks 18 (only one shown for simplicity of illustration) configured in a hub-and-spoke type configuration, and may also be configured for receiving signals from one or more of the trunks. Typically, a plurality of feeder lines 20 branch off the trunk at one or more taps 22 (only one tap and feeder line shown for simplicity) for servicing a relatively small number of end users 24 in a local distribution area served by each feeder line. An end user typically will have one or more consumer electronics (CE) devices 25, such as one or more televisions, personal computers or the like, connected to the system via a feeder line for consuming the signals.

Along the trunks, the system 10 may include one or more distribution amplifiers 26 for amplifying signals transmitted from the head-end facility 12 to the end users 24 (referred to herein as forward signals) and for amplifying signals sent from the end users to the head-end facility (referred to herein as return signals). To interconnect sections of the trunks, the system may also include one or more line connectors 28 at one or more points in the system, such as at one or more points along the trunks 18, feeder lines 20 or the like. Further, the system may include one or more filters or traps 30 at one or more of the taps 22 for decoding or recovering scrambled signals that respective end users are authorized to receive (e.g., signals for subscribed-to pay TV channels), or for otherwise blocking or attenuating signals that respective end users are not authorized to receive.

As explained in the background section, bi-directional CATV systems usually utilize one frequency band for forward signals and a different frequency band for return signals, and within each band, often allocate portions to particular traffic streams. And although such allocations are adequate for communicating across the system, these allocations may be undesirable, such as in those instances where an added traffic stream is desired but the desired portion of a band, or even the entire band, has already been allocated to one or more other traffic streams.

Exemplary embodiments of the present invention therefore provide a system, apparatus and method for embedding an auxiliary signal within a CATV traffic stream. More particularly, exemplary embodiments of the present invention watermark a CATV traffic stream with an auxiliary signal, which may be detected and removed from the traffic stream before it reaches its intended destination, whether the CE device(s) 25 of the end user 24 or the head-end facility 12. By watermarking the traffic stream with the auxiliary signal, the auxiliary signal may be transmitted across the CATV system in the same portion of the same frequency band as the traffic stream, thereby avoiding issues of frequency allocation or reserving a fixed portion of a frequency band in the system. Moreover, the system, apparatus and method of exemplary embodiments of the present invention may be retrofitted within existing or legacy CATV systems, operating in a manner transparent to the legacy components of the system. Thus, for example, the head-end facility may deliver the same CATV signals to an end user as in a conventional CATV system, while auxiliary signals are communicated between various points along the communication path between the head-end facility and the end user.

Referring now to FIG. 2, a block diagram of an embedding/detecting apparatus 32 is shown in accordance with one embodiment of the present invention. As shown and described herein, embedding/detecting apparatuses may be located at various points within the system 10, but for purposes of example, are described herein as being located at the head-end facility 12 and at a connector 28 or trap 30. As also shown and described herein, the embedding/detecting apparatus may be configured to watermark a CATV traffic stream with an auxiliary signal, and/or to detect and remove an auxiliary signal from a watermarked traffic stream. In this regard, for unidirectional communication, an apparatus at the head-end facility may be configured to watermark a CATV traffic stream with an auxiliary signal, while an apparatus at the connector/trap may be configured to detect and remove the auxiliary signal from the watermarked traffic stream. For bidirectional communication, on the other hand, the apparatuses at the head-end facility and connector/trap may be configured to both watermark a traffic stream, and detect and remove an auxiliary signal from a traffic stream.

The embedding/detecting apparatus 32 includes various means for performing one or more functions in accordance with exemplary embodiments of the present invention, including those more particularly shown and described herein. It should be understood, however, that one or more of the entities may include alternative means for performing one or more like functions, without departing from the spirit and scope of the present invention. More particularly, for example, as shown in FIG. 2, the embedding/detecting apparatus includes a transmitter 34, a receiver 36 and a controller 38 or other processor that provides signals to and receives signals from the transmitter and receiver, respectively. The controller generally includes logic elements required for implementing the functions of the apparatus as shown and described herein. The logic elements can be embodied in any of a number of different manners such as, for example, in an integrated circuit assembly including one or more integrated circuits. Additionally or alternatively, for example, the logic elements can be embodied in a digital signal processor device, a microprocessor device, and/or various analog-to-digital converters, digital-to-analog converters, and/or other support circuits.

As shown, the controller 38 is connected to a memory 40. The memory can comprise volatile and/or non-volatile memory, and typically stores content, data or the like. For example, the memory typically stores content transmitted from, and/or received by, the apparatus 32. Also for example, in various instances, the memory may store software programs, instructions or the like for the controller to perform steps associated with operation of the apparatus in accordance with exemplary embodiments of the present invention.

The controller 38 may be further connected to an auxiliary signal interface 42 for receiving auxiliary signals with which to watermark a traffic stream, and/or for sending auxiliary signals detected and removed from a watermarked traffic stream. In this regard, auxiliary signals with which to watermark a traffic stream may be received from one or more of a number of different sources including, for example, a computing device such as a personal computer, laptop computer, microcomputer or the like. Additionally or alternatively, for example, the sources may include one or more sensors, such as sensors for measuring one or more conditions of and/or proximate the apparatus such as RF interference (RFI), moisture, temperature, strain, stress, torque or the like. Similarly, the auxiliary signals detected and removed from a watermarked traffic stream may be sent to any one or more of a number of different destinations including, for example, a computing device. The destination(s) may include the memory 40 for storing the detected auxiliary signal. Additionally or alternatively, the destination(s) may include the controller, such as in the case of an auxiliary signal including control information for directing operation of the controller, and thus, the apparatus.

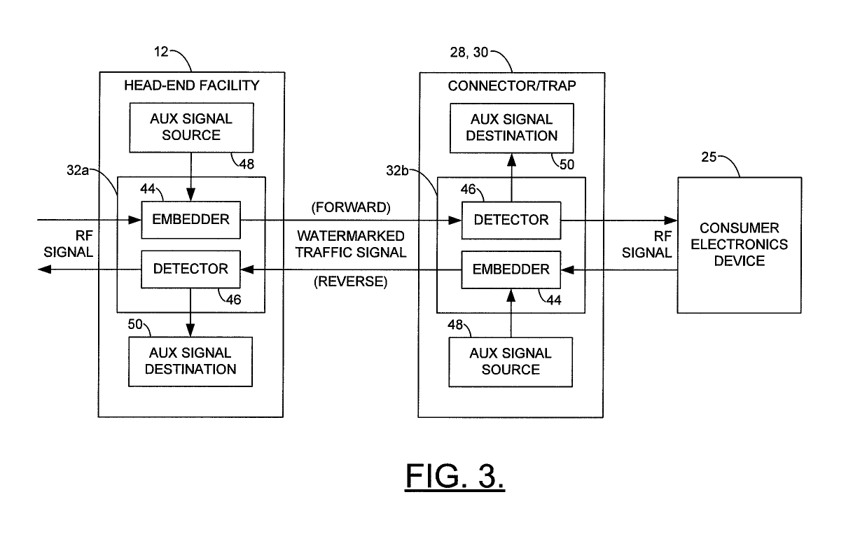

Reference is now made to FIG. 3, which illustrates a functional block diagram of a system for embedding/detecting an auxiliary signal within a traffic stream. As shown, the system includes a first embedding/detecting apparatus 32a and a second embedding/detecting apparatus 32b respectively located at the head-end facility 12 and connector 28 or trap 30 of a CATV system. As shown, the first and second embedding/detecting apparatuses each include an embedder 44 and a detector 46 for watermarking a traffic stream, and detecting and removing an auxiliary signal from a traffic stream, respectively. The illustrated first and second embedding/detecting apparatuses are both configured for bi-directional communication, however, it should again be noted that one or both of the apparatuses may be configured for only unidirectional communication. In such instances, one or both of the apparatuses may include either an embedder or detector, although for effective communication at least one of the apparatuses typically includes at least an embedder and at least one of the other apparatuses typically includes at least a detector.

More particularly, the embedder 44 may be configured for receiving an RF signal from an RF signal source, such as a satellite dish 14, antenna 16, trunk 18 or the like, and for receiving an auxiliary signal from an auxiliary (aux) signal source 48, such as a computing device and/or one or more sensors. The embedder may be configured for watermarking the RF signal with the auxiliary signal, or otherwise embedding the auxiliary signal within the RF signal, for transmission such as to the detector 46 of another embedding/detecting apparatus 32. The detector may be configured for detecting the auxiliary signal within the watermarked RF signal, and removing the auxiliary signal from the watermarked RF signal, thereby resulting in separate RF and auxiliary signals. The detector may then be configured for sending the RF signal to an RF destination, such as a device at the head-end facility 12, a CE device 25 or the like, and sending the auxiliary signal to an auxiliary destination 50, such as a computing device, the controller 38 and/or memory 40 of the respective embedding/detecting apparatus, or the like.

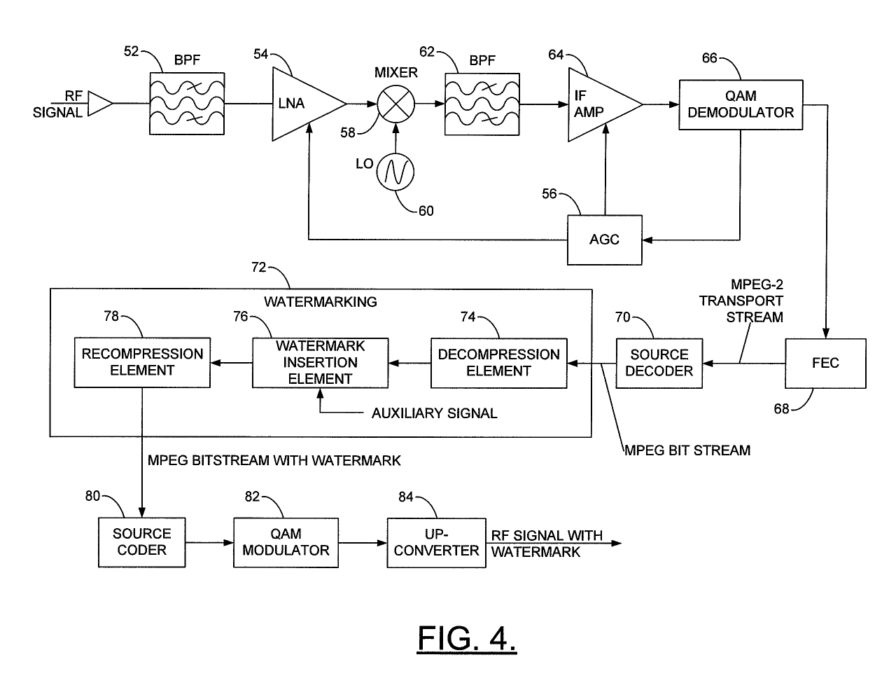

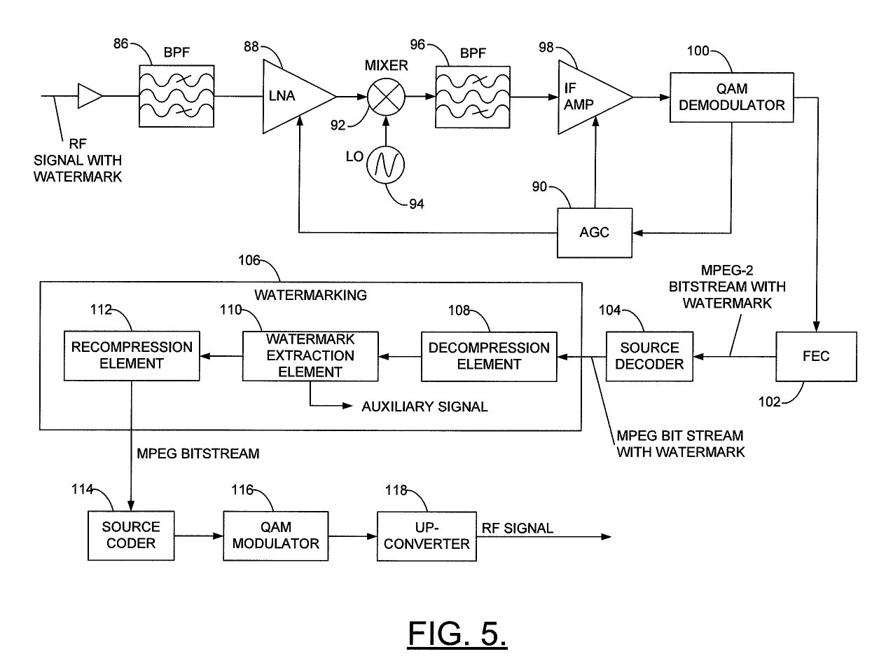

FIGS. 4 and 5 illustrate functional block diagrams of an embedder 44 and a detector 46, respectively, in accordance with one exemplary embodiment of the present invention. As shown in FIG. 4, the embedder may include a first band-pass filter (BPF) 52 for receiving an RF signal and band limiting an RF signal, such as to a single 6 MHz channel, which may reduce the power and complexity required for the other elements of the embedder. The band-limited signal may then pass to a low-noise amplifier (LNA) 54 for amplifying the signal with a particular gain, which may be controlled by an automatic gain controller (AGC) 56. The LNA output may then be fed to a mixer 58 for mixing the RF signal with a signal from a local oscillator (LO) 60 to thereby convert the RF signal to an intermediate frequency (IF) signal. The IF signal may then be passed through another, second BPF 62 to remove any artifacts from the signal, and through an IF amplifier 64 whose gain may also be controlled by the AGC. As will be appreciated, the first BPF, LNA, AGC, mixer, LO, second BPF and IF amplifier may form a tuner for the embedder 44. And as will also be appreciated, one or more of the aforementioned elements may not be required or otherwise included in the tuner. For example, the RF signal need not be converted to an IF signal, and as such, the tuner (and thus the embedder) need not include a mixer or LO. Conversion of the signal to an IF signal, however, may permit use of more readily available off-the-shelf components for other elements of the embedder.

In various instances, the RF signal received by the embedder 44 may be modulated in accordance with any of a number of modulation schemes. In CATV systems, for example, the RF signal may comprise a quadrature amplitude modulation (QAM) modulated digital signal, such as a QAM modulated MPEG-2 transport stream. In such instances, following the IF amplifier 64, the IF signal may pass to a demodulator, such as a QAM demodulator 66, for demodulating the IF signal. The demodulated signal may then pass to a forward error correction (FEC) element 68 for providing error control. As shown, the FEC element is separate from the demodulator; it should be understood, however, that the FEC element may alternatively be functionally integral with the demodulator. The output of the FEC element may therefore comprise, for example, a MPEG-2 transport stream.

The transport stream output of the FEC element 68 may pass to a source decoder 70, such as a MPEG source decoder, for decoding the transport stream into a bit stream, such as an MPEG bitstream. The bit stream (e.g., MPEG bit stream) may be fed to a watermarking element 72 for watermarking the bit stream with an auxiliary signal. The watermarking element may watermark the bit stream in accordance with any of a number of different schemes known to those skilled in the art including, for example, variable length coding (VLC) watermarking, discrete cosine transform (DCT) watermarking, quantized DCT (QDCT) watermarking, spatial watermarking or the like. Depending on the chosen watermarking domain, the MPEG bit stream may be decompressed by a decompression element 74. The decompression element can be the inverse variable length coder (VLC⁻¹), or VLC⁻¹ plus an inverse quantizer (Q⁻¹), or VLC⁻¹ plus VLC⁻¹ plus inverse discrete cosine transform element (DCT⁻¹). If the watermarking is performed in a bit stream domain, however, the watermarking element need not include a decompression element. In addition to the decompression element (if appropriate), the watermarking element may also include a watermark insertion element 76 configured for inserting the auxiliary signal in the bit stream, such as according to any of a number of different algorithms. Thereafter, a recompression element 78 may recompress the watermarked bit stream (e.g., MPEG bit stream), although the watermarking element need not include such a recompression element if the watermarking is performed in a bit stream domain.

The watermarking element 72 outputs a watermarked bit stream (e.g., MPEG bit stream) including the auxiliary signal. The watermarked bit stream may then be received by a source coder 80 (e.g., MPEG source coder) for coding the watermarked bit stream into a watermarked transport stream (e.g., MPEG-2 transport stream), such as in the inverse manner as the source decoder decoded the input bit stream. The watermarked transport stream may then be passed to a modulator, such as a QAM modulator 82, for modulation (e.g., QAM modulation), and to an up-converter 84 for up-conversion from its IF to RF. The watermarked RF signal may then be passed for transmission (by transmitter 34).

Generally, the detector 46 includes elements for performing the inverse of the operations of the embedder 44 to detect and remove an auxiliary signal from a watermarked traffic stream, such as that from an embedder. More particularly, as shown in FIG. 5, for example, the detector may include a tuner similar to that of the embedder for preparing the watermarked traffic stream, where the tuner may include a first BPF 86, a LNA 88, an AGC 90, a mixer 92, a LO 94, a second BPF 96 and an IF amplifier 98. Similar to the tuner of the embedder, the tuner of the detector may output modulated, watermarked RF signal, which may be demodulated by a demodulator (e.g., QAM demodulator 100), and passed through a FEC element 102 and source decoder 104 (e.g., MPEG source decoder).

The output of the source decoder 104 may comprise a watermarked bit stream (e.g., MPEG bit stream) that may be fed to a watermarking element 106 for detecting and removing an auxiliary signal from the watermarked the bit stream. Similar to the watermarking element 72 of the embedder 44, the watermarking element of the detector may detect and remove the auxiliary signal from the watermarked bit stream in accordance with any of a number of different schemes, although typically in accordance with the same technique with which the embedder watermarked the bit stream. Thus, for example, the watermarking element may include a decompression element 108 for decompressing the watermarked bit stream, after which a watermark extraction element 110 extracts the auxiliary signal form the watermarked bit stream, and a recompression element 112 recompresses the resulting bit stream (e.g., MPEG bit stream). Although, again, the watermarking element need not include the decompression and recompression elements if the watermarking, and in turn the extraction, is performed in a bit stream domain.

The watermarking element 106 outputs a bit stream (e.g., MPEG bit stream), and separately outputs the auxiliary signal. The output bit stream may then be received by a source coder 114 (e.g., MPEG source coder) for coding the bit stream into a transport stream (e.g., MPEG-2 transport stream), which may then be received by a modulator (e.g., QAM modulator 116), for modulation (e.g., QAM modulation). The modulated transport stream may then be up converted from IF to RF by an up-converter 118. The RF signal may then be passed for transmission (by transmitter 34).

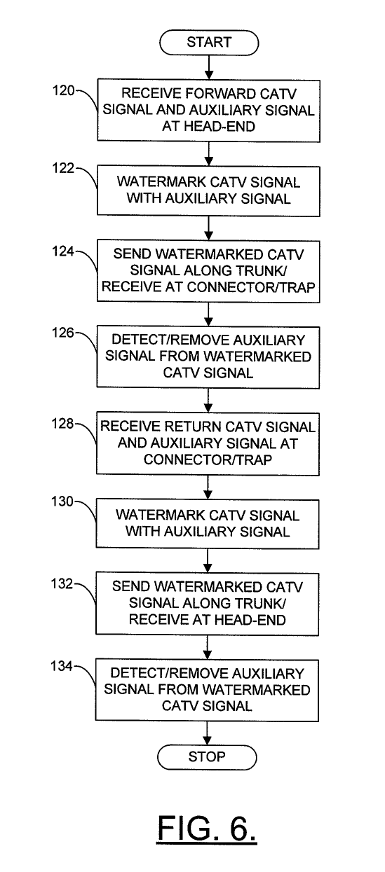

Reference is now made to FIG. 6, which illustrates various steps in a method of embedding/detecting an auxiliary signal within a traffic stream, in accordance with exemplary embodiments of the present invention. The method will be described without loss of generality to a CATV system wherein a first embedding/detecting apparatus 32a is located at a head-end facility 12 for bi-directionally communicating with a second embedding/detecting apparatus 32b located at a connector 28 or trap 30. In addition, the method will be described without loss of generality to an exemplary scenario in which the head-end facility desires to acquire information regarding one or more conditions proximate the aforementioned connector or trap.

The method includes the first embedding/detecting apparatus 32a at the head-end facility 12 receiving a forward CATV signal, and an auxiliary signal including control information for directing operation of the second embedding/detecting apparatus 32b, as shown in block 120. This control information may include, for example, commands from a computing device (auxiliary signal source 48) for directing the second embedding/detecting apparatus to acquire measurements from one or more sensors in communication with the second embedding/detecting apparatus. In various instances it may also be necessary for the auxiliary signal to also include addressing information identifying the particular second embedding/detecting apparatus, particularly in instances in which the CATV system includes more than one embedding/detecting apparatuses positioned at various points along one or more trunks 18.

After receiving the CATV signal and auxiliary signal, the first embedding/detecting apparatus 32a watermarks the CATV signal with the auxiliary signal, or otherwise embeds the auxiliary signal in the CATV signal, as shown in block 122. The first embedding/detecting apparatus then sends the watermarked CATV signal or traffic stream over one or more trunks 18 for receipt by the connector 28 or trap 30 including the second embedding/detecting apparatus 32b, as shown in block 124. As explained above, by watermarking the CATV signal with the auxiliary signal, the auxiliary signal may be transmitted across the CATV system in the same portion of the same frequency band as the CATV signal, thereby avoiding issues of frequency allocation or reserving a fixed portion of a frequency band in the CATV system.

As the watermarked traffic stream propagates along a trunk 18, the second embedding/detecting apparatus 32b receives the watermarked traffic stream, and processes the traffic stream to detect and remove the auxiliary signal therefrom, as shown at block 126. The second embedding/detecting apparatus then forwards the CATV signal or traffic stream, without the auxiliary signal, further along the trunk to its intended destination in the context of a conventional CATV system. Thus, for example, the CATV signal or traffic stream may be delivered to one or more a CE devices 25 in the same manner as that signal may be delivered in a conventional CATV system.

The second embedding/detecting apparatus 32b, or more particularly the controller 38 (auxiliary signal destination 50), interprets the control information, or more particularly the commands of the control information. In response to the commands, the second embedding/detecting apparatus communicates with one or more sensors in communication therewith to acquire measurements for one or more conditions proximate the second embedding/detecting apparatus. As indicated above, these sensors may include, for example, sensors for measuring one or more conditions proximate the apparatus such as RF interference (RFI), moisture, temperature, strain, strain, torque or the like. Upon receipt of the appropriate measurements from the sensor(s) (auxiliary signal sources 48), the second embedding/detecting apparatus may perform any appropriate processing of the measurements to prepare those measurements as an auxiliary signal to return to the head-end facility 12 and the first embedding/detecting apparatus 32a.

Along with the measurements from the sensor(s), the second embedding/detecting apparatus 32b may also receive a return CATV signal such as from one or more CE devices 25 during conventional operation of the CATV system, or may alternatively generate a return CATV signal, as shown in block 128. Then, irrespective of whether the second embedding/detecting apparatus processes the measurements from the sensor(s), the measurements may constitute an auxiliary signal with which the second embedding/detecting apparatus watermarks or embeds the return CATV signal, as shown in block 130. The second embedding/detecting apparatus then sends the watermarked CATV signal or traffic stream over its respective trunk 18 to the head-end facility 12, as shown in block 132. Again, by watermarking the return CATV signal with the auxiliary signal, the auxiliary signal may be transmitted across the CATV system in the same portion of the same frequency band as the CATV signal.

The return watermarked CATV signal or traffic stream may terminate at the head-end facility 12 where the first embedding/detecting apparatus 32a receives the watermarked traffic stream, and processes the traffic stream to detect and remove the auxiliary signal (sensor measurements) therefrom, as shown in block 134. The first embedding/detecting apparatus then forwards the CATV signal or traffic stream, and separately the auxiliary signal, to appropriate destinations for use thereby. In this regard, the first embedding-detecting apparatus may forward the CATV signal or traffic stream to other portions of the head-end facility for any processing thereof, such as in the context of a conventional CATV system. Separately, the first embedding/detecting apparatus may forward the auxiliary signal (sensor measurements) to an auxiliary signal destination 50, such as the same computing device from which the first embedding/detecting apparatus originally receive the control information auxiliary signal. Then, at the auxiliary signal destination, the measurements may be processed or otherwise utilized for any of a number of different purposes, such as for monitoring the conditions of the CATV system.

According to one aspect of the present invention, the functions performed by one or more of the entities or elements of the embedding/detecting apparatus 32 may be performed by various means, such as hardware and/or firmware, including those described above, alone and/or under control of a computer program product. The computer program product for performing one or more functions of embodiments of the present invention includes a computer-readable storage medium, such as the non-volatile storage medium, and software including computer-readable program code portions, such as a series of computer instructions, embodied in the computer-readable storage medium.

In this regard, FIG. 6 is a flowchart of systems, methods and program products according to exemplary embodiments of the present invention. It will be understood that each block or step of the flowchart, and combinations of blocks in the flowchart, can be implemented by various means, such as hardware, firmware, and/or software including one or more computer program instructions. As will be appreciated, any such computer program instructions may be loaded onto a computer or other programmable apparatus (i.e., hardware) to produce a machine, such that the instructions which execute on the computer or other programmable apparatus create means for implementing the functions specified in the flowchart's block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart's block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart's block(s) or step(s).

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. An apparatus comprising:
a controller configured for receiving an input signal and an auxiliary signal, and watermarking the input signal with the auxiliary signal to thereby form a watermarked signal,
wherein the controller is configured for sending the watermarked signal to a detector for detecting and removing the auxiliary signal from the watermarked signal to thereby recover the input signal and the auxiliary signal,
wherein the apparatus is configured for inclusion within a legacy cable television (CATV) system configured for sending one or more CATV signals in respective one or more frequency bands, wherein the input signal comprises one of the CATV signals of the CATV system, the watermarked signal being sent to the detector in the same frequency band as the respective CATV signal.

2. An apparatus according to claim 1, wherein the detector forms a portion of another apparatus, wherein the controller is configured for sending the watermarked signal to the detector such that the other apparatus forwards the recovered input signal to a head-end facility or consumer electronics device of the CATV system.

3. An apparatus according to claim 1, wherein the auxiliary signal with which the controller watermarks the input signal comprises measurements of one or more conditions of the apparatus or proximate the apparatus, the measurements being received by one or more sensors in communication with the controller.

4. An apparatus according to claim 1, wherein the detector forms a portion of another apparatus, and wherein the auxiliary signal with which the controller watermarks the input signal comprises control information for directing operation of the other apparatus.

5. An apparatus according to claim 4, wherein the control information includes one or more commands for directing the other apparatus to acquire measurements of one or more conditions of the other apparatus or proximate the other apparatus.

6. An apparatus according to claim 1, wherein the input signal, auxiliary signal and watermarked signal comprise a first watermarked signal, a first auxiliary signal and a first watermarked signal respectively,
wherein the controller is further configured for receiving a second watermarked signal from an embedder, the embedder having formed the second watermarked signal by watermarking a second input signal with a second auxiliary signal, and
wherein the controller is configured for detecting and removing the second auxiliary signal from the second watermarked signal to thereby recover the second input signal and the second auxiliary signal,
wherein the second input signal comprises one of the CATV signals of the CATV system, the second watermarked signal being received by the controller in the same frequency band as the respective CATV signal.

7. An apparatus according to claim 6, wherein the controller is configured for forwarding the recovered second input signal to a head-end facility or consumer electronics device of the CATV system.

8. An apparatus according to claim 6, wherein the embedder forms a portion of another apparatus, wherein the second auxiliary signal comprises measurements of one or more conditions of the other apparatus or proximate the other apparatus, the measurements being received by one or more sensors in communication with the other apparatus.

9. An apparatus according to claim 6, wherein the second auxiliary signal comprises control information for directing operation of the apparatus.

10. An apparatus according to claim 9, wherein the control information includes one or more commands for directing the apparatus to acquire measurements of one or more conditions of the apparatus or proximate the apparatus, the controller being configured to acquire the measurements in response to the commands.

11. An apparatus comprising:
a controller configured for receiving a watermarked signal from an embedder, the embedder having formed the watermarked signal by watermarking an input signal with an auxiliary signal, and
wherein the controller is configured for detecting and removing the auxiliary signal from the watermarked signal to thereby recover the input signal and the auxiliary signal,
wherein the apparatus is configured for inclusion within a legacy cable television (CATV) system configured for sending one or more CATV signals in respective one or more frequency bands, wherein the input signal comprises one of the CATV signals of the CATV system, the watermarked signal being received from the embedder in the same frequency band as the respective CATV signal.

12. An apparatus according to claim 11, wherein the controller is configured for forwarding the recovered second input signal to a head-end facility or consumer electronics device of the CATV system.

13. An apparatus according to claim 11, wherein the embedder forms a portion of another apparatus, wherein the auxiliary signal comprises measurements of one or more conditions of the other apparatus or proximate the other apparatus, the measurements being received by one or more sensors in communication with the other apparatus.

14. An apparatus according to claim 11, wherein the auxiliary signal comprises control information for directing operation of the apparatus.

15. An apparatus according to claim 14, wherein the control information includes one or more commands for directing the apparatus to acquire measurements of one or more conditions of the apparatus or proximate the apparatus, the controller being configured to acquire the measurements in response to the commands.

16. A method comprising:
providing an apparatus within a legacy cable television (CATV) system configured for sending one or more CATV signals in respective one or more frequency bands;
receiving an input signal and an auxiliary signal at the apparatus, and watermarking the input signal with the auxiliary signal to thereby form a watermarked signal, wherein the input signal comprises one of the CATV signals of the CATV system; and
sending the watermarked signal from the apparatus to a detector for detecting and removing the auxiliary signal from the watermarked signal to thereby recover the input signal and the auxiliary signal, the watermarked signal being sent to the detector in the same frequency band as the respective CATV signal.

17. A method according to claim 16, wherein the detector forms a portion of another apparatus, wherein sending the watermarked signal comprises sending the watermarked signal to the detector such that the other apparatus forwards the recovered input signal to a head-end facility or consumer electronics device of the CATV system.

18. A method according to claim 16, wherein receiving an auxiliary signal comprises receiving an auxiliary signal comprising measurements of one or more conditions of the apparatus or proximate the apparatus, the measurements being received by one or more sensors in communication with the apparatus.

19. A method according to claim 16, wherein the detector forms a portion of another apparatus, and wherein receiving an auxiliary signal comprises receiving an auxiliary signal comprising control information for directing operation of the other apparatus.

20. A method according to claim 19, wherein receiving an auxiliary signal comprises receiving an auxiliary signal comprising the control information including one or more commands for directing the other apparatus to acquire measurements of one or more conditions of the other apparatus or proximate the other apparatus.

21. A method according to claim 16, wherein the input signal, auxiliary signal and watermarked signal comprise a first watermarked signal, a first auxiliary signal and a first watermarked signal respectively, wherein the method further comprises:
receiving a second watermarked signal at the apparatus from an embedder, the embedder having formed the second watermarked signal by watermarking a second input signal with a second auxiliary signal, wherein the second input signal comprises one of the CATV signals of the CATV system, the second watermarked signal being received by the apparatus in the same frequency band as the respective CATV signal; and
detecting and removing the second auxiliary signal from the second watermarked signal at the apparatus to thereby recover the second input signal and the second auxiliary signal.

22. A method according to claim 21 further comprising:
forwarding the recovered second input signal from the apparatus to a head-end facility or consumer electronics device of the CATV system.

23. A method according to claim 21, wherein the embedder forms a portion of another apparatus, and wherein the second auxiliary signal comprises measurements of one or more conditions of the other apparatus or proximate the other apparatus, the measurements being received by one or more sensors in communication with the other apparatus.

24. A method according to claim 21, wherein the second auxiliary signal comprises control information for directing operation of the apparatus.

25. A method according to claim 24, wherein the control information includes one or more commands for directing the apparatus to acquire measurements of one or more conditions of the apparatus or proximate the apparatus, and wherein the method further comprises:
acquiring the measurements in response to the commands.

26. A method comprising:
providing an apparatus within a legacy cable television (CATV) system configured for sending one or more CATV signals in respective one or more frequency bands;
receiving a watermarked signal at the apparatus from an embedder, the embedder having formed the watermarked signal by watermarking an input signal with an auxiliary signal, wherein the input signal comprises one of the CATV signals of the CATV system, the watermarked signal being received from the embedder in the same frequency band as the respective CATV signal; and
detecting and removing the auxiliary signal from the watermarked signal at the apparatus to thereby recover the input signal and the auxiliary signal.

27. A method according to claim 26 further comprising:
forwarding the recovered second input signal to a head-end facility or consumer electronics device of the CATV system.

28. A method according to claim 26, wherein the embedder forms a portion of another apparatus, wherein the auxiliary signal comprises measurements of one or more conditions of the other apparatus or proximate the other apparatus, the measurements being received by one or more sensors in communication with the other apparatus.

29. A method according to claim 26, wherein the auxiliary signal comprises control information for directing operation of the apparatus.

30. A method according to claim 29, wherein the control information includes one or more commands for directing the apparatus to acquire measurements of one or more conditions of the apparatus or proximate the apparatus, and wherein the method further comprises:
acquiring the measurements in response to the commands.
